(19) United States
(12) Patent Application Publication
(10) Pub. No.: US 2024/0169700 A1
(43) Pub. Date: May 23, 2024

(54) Image Annotation Methods Based on Textured Mesh and Camera Pose

(71) Applicant: CareAR Holdings LLC, Norwalk, CT (US)

(72) Inventors: Fritz Ebner, Pittsford, NY (US); Matthew Shreve, Campbell, CA (US); Ben Pinkerton, Powell, OH (US); Chetan Gandhi, New York, NY (US)

(21) Appl. No.: 18/057,341

(22) Filed: Nov. 21, 2022

(51) Int. Cl. G06V 10/774; G06T 7/70; G06T 17/20; G06T 19/00; G06V 20/20; G06V 20/70

(52) U.S. Cl. CPC G06V 10/774; G06T 7/70; G06T 17/20; G06T 19/006; G06V 20/20; G06V 20/70; G06T 2207/10024; G06T 2207/10028; G06T 2207/20081; G06T 2207/20084; G06T 2207/30244; G06T 2210/12; G06T 2219/004

(57) ABSTRACT

A system for generating a labelled image data set for use in object detection training includes a three-dimensional scan of an object and its environment in a coordinate space generated using a set of images taken by a user device. The three-dimensional scan has an annotation of the object in the coordinate space. Each image in the set of images has position information of the user device in the coordinate space. A computing system is adapted to annotate the set of images by projecting the annotation of the object onto each image using the position information. The computing system is adapted to generate a labelled image set for teaching object detection using the annotated set of images.

### TECHNICAL FIELD

The present teachings relate generally to augmented reality and, more particularly, to systems and methods for annotating images that may be used for teaching object detection.

### BACKGROUND

Augmented reality (AR) is an interactive experience with a real-world environment where real-world objects are enhanced with computer-generated information. Computer-generated information can be both constructive (i.e., overlaid and additive) and destructive (i.e., masking). AR typically incorporates a combination of real and virtual worlds, real-time interaction, and 3D registration of virtual and real-world objects.

Object detection (also referred to as AR object recognition) associates a digital model to a real-world object so that it can be identified and manipulated in a virtual context. This could include, for example, identifying object states and adding augmentation (annotation), which may in the form of labels and other identifiers (e.g., overlayed instructions, bounding boxes, labelled parts, etc.). In addition, users in an AR system can interact with a real-world object that is being simulated. This could include adjusting the object (e.g., opening or closing parts, etc.).

Before a user can interact with a real-world object in the AR context, that real-world object needs to be scanned so that a digital model (e.g., simulated 3D object) can be created. This includes scanning different states of the real-world object (e.g., door on a printer open and closed, etc.). An object model is generated by training an object detector to identify the object using the annotated (e.g., labeled) set of the images, for example using deep learning object detection neural networks.

In order to create an object model, images from the scanning process are annotated (e.g., labelled) with tags or labels to make objects recognizable to machines so they can detect similar objects and predict the results accurately. In the field of computer vision, the label identifies elements within the image. The annotated dataset is used to teach the model by example. Data labelling is an important element for machine learning and flaws in labelling can lead to lower success rates of the model. Accordingly, it is desirable to create a high-quality data set for artificial intelligence (AI) model training.

U.S. Pat. No. 11,200,457, entitled “System and method using augmented reality for efficient collection of training data for machine learning,” discloses a system for collecting training data. One drawback with the teachings of the '457 patent that it does not provide for remote (e.g., asynchronous) annotation. Thus, annotation errors can be introduced at the time of scanning, requiring scanning again, which increases time and cost.

Therefore, it would be beneficial to have an alternative system and method for image annotation based on textured mesh and camera pose.

### SUMMARY

The needs set forth herein as well as further and other needs and advantages are addressed by the present embodiments, which illustrate solutions and advantages described below.

A system for generating a labelled image data set for use in object detection training according to the present teachings includes, but is not limited to, a three-dimensional scan of an object and its environment in a coordinate space generated using a set of images taken by a user device. The three-dimensional scan has an annotation of the object in the coordinate space. Position information of the user device in the coordinate space is provided for each image in the set of images. A computing system is adapted to annotate the set of images by projecting the annotation of the object onto each image using the position information. The computing system is adapted to generate a labelled image set for teaching object detection using the annotated set of images.

In one embodiment, the three-dimensional scan is generated by the user device and sent to the computing system over the Internet, the annotation is added to the three-dimensional scan by the user device, the annotation including a bounding box on the object, and the position information for each image is generated by the user device and sent to the computing system, the position information including six degrees of freedom information of the user device in the coordinate space.

In one embodiment, the set of images comprises video.

In one embodiment, the computing system is adapted to generate the three-dimensional scan using the set of images received from the user device.

In one embodiment, the position information for each image is generated by the computing system.

In one embodiment, the set of images further comprises images generated by the computing system by varying perspective of the object in the three-dimensional scan.

In one embodiment, the annotation is added to the three-dimensional scan by the computing system.

In one embodiment, the annotation comprises a bounding box on the object.

An object model for object detection includes, but is not limited to, the labeled image data set generated by the system according to the present teachings. The computing system is adapted to generate the object model by training an object detector to identify the object using the labeled image data set, and using deep learning object detection neural networks.

In one embodiment, the computing system comprises a plurality of processors in communication over a network.

In one embodiment, each image of the set of images comprises depth information.

In one embodiment, each image of the set of images comprises an RGB-D image.

An augmented reality support platform includes, but is not limited to, a server having an object model generated by training an object detector using the labeled image data set generated by the system according to the present teachings. The server is adapted to receive video from a mobile device. The server is adapted to identify an object in the video using the object model. The server is adapted to annotate the video based on the identified object and transmit the annotated video to the mobile device for presentation. The identified object is a part of a product that is being supported and the server is adapted to provide tasks for troubleshooting support of the product, and to detect whether a task has been completed.

A system for generating a labelled image data set for use in object detection training according to the present teachings includes, but is not limited to, a computing system adapted to receive a sequence of images of an object and its environment taken by a user device, each image of the sequence of images having position information of the user device in a coordinate space. A three-dimensional scan of the object and its environment is generated using the sequence of images, the three-dimensional scan having an annotation of the object in the coordinate space. The computing system is adapted to annotate the sequence of images by projecting the annotation of the object onto each image using the position information. The computing system is adapted to generate a labelled image set for teaching object detection using the annotated sequence of images.

An augmented reality support platform includes, but is not limited to, a server having an object model generated by training an object detector using the labeled image data set generated by the system of the present teachings. The server is adapted to receive video from a mobile device. The server is adapted to identify an object in the video using the object model. The server is adapted to annotate the video based on the identified object and transmit the annotated video to the mobile device for presentation. The identified object is a part of a product that is being supported and the server is adapted to provide tasks for troubleshooting support of the product, and to detect whether a task has been completed.

In one embodiment, the set of images further comprises images generated by the computing system by varying perspective of the object in the three-dimensional scan.

In one embodiment, the sequence of images comprises video.

In one embodiment, the three-dimensional scan is generated by the user device.

A method for generating a labelled image data set for use in object detection training according to the present teachings includes, but is not limited to; providing a three-dimensional scan of an object and its environment in a coordinate space generated using a set of images taken by a user device; providing in the three-dimensional scan an annotation of the object in the coordinate space; providing position information of the user device in the coordinate space for each image in the set of images; annotating the set of images with a computing system by projecting the annotation of the object onto each image using the position information; generating a labelled image set for teaching object detection using the annotated set of images.

In one embodiment, the three-dimensional scan is generated by the user device and sent to the computing system over the Internet, the annotation is added to the three-dimensional scan by the user device, the annotation including a bounding box on the object, and the position information for each image is generated by the user device and sent to the computing system, the position information including six degrees of freedom information of the user device in the coordinate space.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIGS. 1A-1B are a diagram of one embodiment of the system according to the present teachings

FIGS. 2A-2C are illustrations of use of an AR framework for capturing labeled images.

FIG. 3 is an illustration of a labelled image.

FIG. 4 is an illustration of a synthetic object based on a CAD model on a synthetic background.

FIGS. 5A-C are illustrations of a captured scene that is annotated.

FIG. 6 is an illustration of an example projection according to the present teachings.

FIGS. 7A-7C are illustrations of example perspectives of a 3D frozen mesh.

FIG. 8 is an illustration of a projection of a camera coordinate system to a world coordinate system according to the present teachings.

FIGS. 9A-9I are example user interfaces for scanning a scene.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of at least one computer-readable medium include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, it is noted that none of the appended claims or claim elements are intended to invoke 35 U.S.C. 112(f) unless the words “means for” or “step for” are explicitly used in the particular claim.

Augmented Reality (AR) is used to enhance real-world objects with computer-generated information. As a basic example, a camera on a smartphone can be used to capture an image of a user's environment and present that image on the smartphone's display. Text, annotations, etc. may be overlayed on the image to label certain objects and/or provide other relevant information. In addition to visual enhancements, AR presentations may use other sensory modalities such as auditory, haptic, somatosensory and olfactory modalities to present relevant information to a user, although not limited thereto.

AR has many different uses including, for example, as part of a support platform. When computer hardware or other physical equipment is not working correctly, a service call is typically placed to a service provider so that remediation can be performed by a support professional (e.g., knowledge expert). However, service calls and follow-up visits can be expensive and impact customer downtime. Using AR, service professionals may provide real-time access to expertise to customers, employees, field workers, etc.

An AR support platform can be used to provide users with instruction workflows that help a user to perform tasks. Tasks can include validation steps, where the system can help detect whether the desired result of the task has been completed. A “desired result” (or “end state”) may be a special case of what can be termed “object states” (e.g., has object door been opened, has part been replaced, etc.). An object state can be any detection of an object which can be differentiated from other states. For example, an object state might comprise a door which is open or closed, or a switch which is on or off, etc.

Objects and their states may be detected using a computer vision approach which employs deep learning networks. Object states may be used to confirm that a task has been accomplished, for example if the back door of a printer has been opened, or if a toner drum has been removed. An object state can be thought of as the ‘context’ of the object that allows an identification or understanding of a state of the object.

Data scientists use annotated image data to train deep neural networks (DNNs), at the core of AI workflows, in order to perform object detection. Obtaining annotated data or annotating data can be challenging and time-consuming. Current methods employ an AR framework (e.g., AR kit, AR core, etc.) to annotate 3D scenes and use the information to capture 2D images with corresponding bounding boxes.

There are different types of image labeling techniques, based on different use-cases, such as bounding boxes, semantic segmentation, polygon annotation, polyline annotation, cuboid annotation, and landmarking annotation. Different techniques may be preferable for specific visual perception model training data algorithm compatibility and requirements to make sure training data is useful for the model.

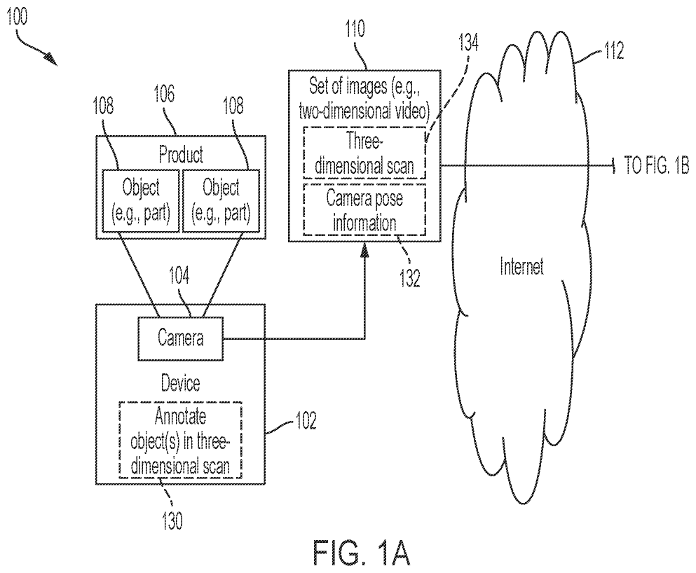

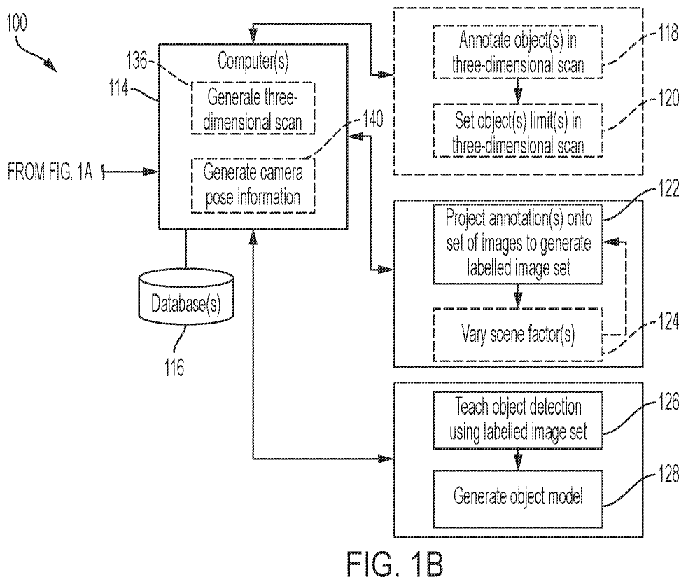

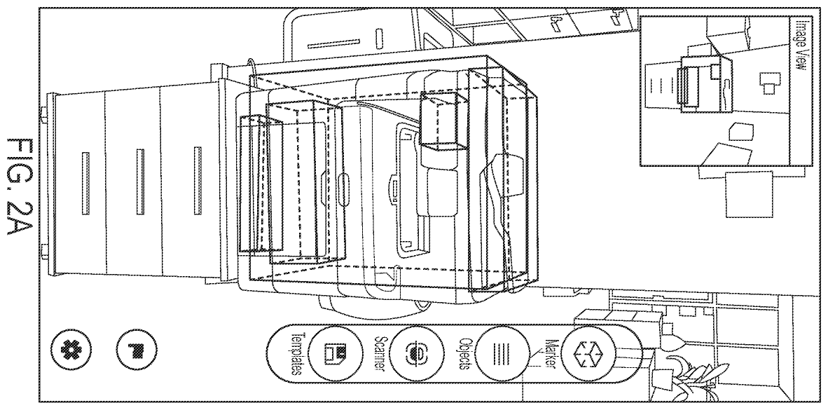

Referring now to FIGS. 1A-1B, shown is a diagram of one embodiment of the system 100 according to the present teachings. A system according to the present teachings addresses deficiencies in known systems and provides for post-image-capture remote annotation (labelling), re-annotation of incorrect annotations, and addition of new annotations, among other benefits.

As shown, a computing device 102 may be equipped with a camera 104 for scanning a product 106 and its parts 108 (objects). The device 102 may be any type of computing device, such as a desktop computer, tablet, mobile device, etc. However, it may be preferable to be a mobile device with a built-in camera 104 for scanning the objects 108. The objects 108 may be, for example, parts of a product 106 being supported or another physical thing.

Sets of images 110 (e.g., video scan) of the product 106 and parts 108 may be sent over a network 112 (e.g., the Internet) to one or more computers 114 (also generically referred to as a “computing system”) that may provide functionality for the present teachings. The sets of images 110 may be in the form of two-dimensional video, and may include color and depth information, although not limited thereto.

The user device 102 may also generate a three-dimensional scan 134 (e.g., from the set of images 110) and send those to the computing system 114. The user device 102 may also generate camera pose information 132 (also referred to as position information) for each image, which may include six degrees of freedom information of the user device 102 in a coordinate space (e.g., the same coordinate space as the three-dimensional scan 134). The three-dimensional scan 134 and camera pose information 132 may also be generated later 136, 140 by the computing system 114, although not limited thereto.

The computer/computing system 114 may include any number of computers/processors, which may communicate with each other over a network and rely on distributed computing resources. The computer 114 may typically be in the form of one or more servers. The computer 114 may include software executing on computer readable media for particular functionality (e.g., functional modules).

A scanner 136 may generate a three-dimensional scan from the set of images 110. A positioner 140 may generate camera pose information for each of the images in the set of images 110. Here, these are not generated by the user device 102, but can instead be part of offline processing by the computing system 114.

The computing system 114 may be in electronic communication with a datastore (e.g., database 116) that may store information on objects, states, products, training materials, support information, user interfaces, etc., as appreciated by one skilled in the art.

The three-dimensional scan may be stored in the database 116 for later retrieval. For example, the scan may be retrieved so an annotator 118 (may be on same or different computing system 114) can annotate objects in the scan. A limiter 120 may be used to set limits on the object annotations. The present teachings allow for asynchronous annotating, i.e., annotating of objects in a three-dimensional scan by the computing system 114 (as opposed to the user device 102).

A scene capturer 122 (may be on same or different computing system 114) may capture the annotated object in the scene by projecting the annotation (e.g., from the three-dimensional scan) on the set of images (e.g., two dimensional). This may include automatically varying perspective and distance to the object to get a set of two-dimensional images with the annotation projected thereon. A scene varier 124 may vary the scene (e.g., lighting, etc.) in order to generate a varied set of labelled images for training an object detector.

Once a labelled image set has been generated, an object detection teacher 126 (may be on same or different computing system 114) may teach object detection using the labelled (annotated) images. A model generator 128 may then generate the resulting object model.

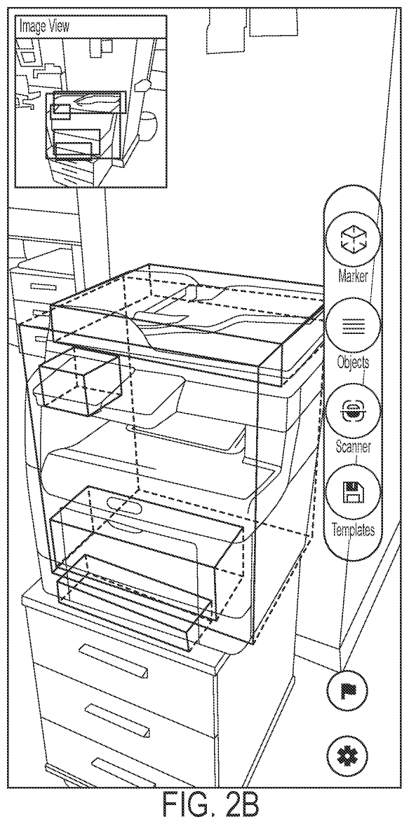

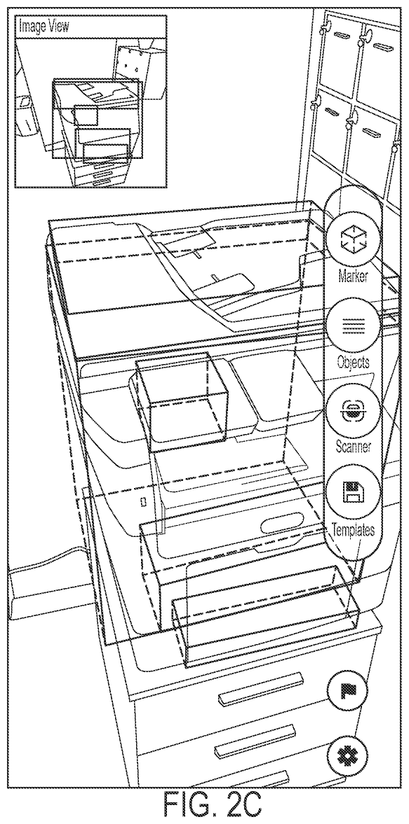

Referring now to FIGS. 2A-2C, shown are illustrations of use of an AR framework for capturing labeled images. A computing system (e.g., software executing on user device 102) can be used to capture labeled images from real scenes using an AR framework. The AR framework allows the capture of labeled images from many different angles and distances. As shown, a “cube” can be dropped in fixed space one time (e.g., FIG. 2A), and image bounding boxes can then be created for each image (e.g., FIGS. 2B-C) with varying perspectives.

Problems with known systems for generating labelled image sets include that annotated images need to be uploaded to an AI platform for processing. As a result, if the images were improperly annotated, for example, they must be deleted and the scene re-scanned by the user device 102. In addition, if a new part/object and/or state is needed after the annotated images are uploaded, the object/state combinations may need to be re-scanned. Still further, annotating images by a user on a user device 102 (in an app) can be time consuming and cumbersome.

In one embodiment according to the present teachings, a scan (e.g., 3D mesh) with annotations, and images with camera pose metadata may be uploaded to an AI platform for processing. The scene can be captured in high detail (e.g., shape and texture) to create a frozen mesh of an object and its environment. The captured 3D mesh may have a well-defined coordinate space. The camera's 104 position information (e.g., 6DOF pose) may be tracked for each image in the same world space as the 3D mesh. Using this information, images can be annotated/reannotated later to fix mistakes or add parts/states by projecting the annotations (e.g., from annotated 3D mesh) onto the images.

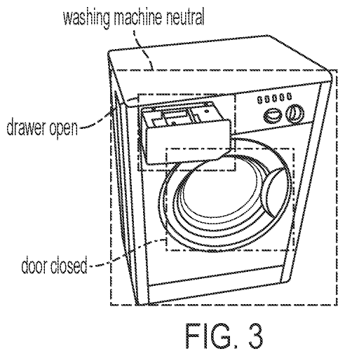

Referring now to FIG. 3, shown is an illustration of a labelled image. Shown are three objects (e.g., that have been detected), along with states. In this example, a washing machine (no state), a drawer in an open state, and a door in the closed state have been detected.

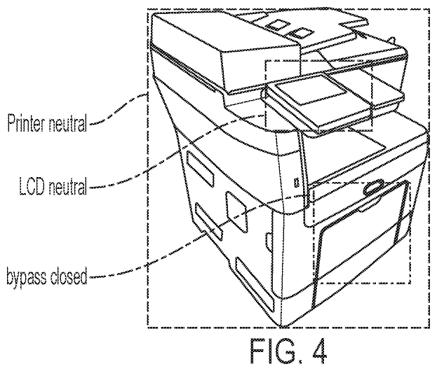

Referring now to FIG. 4, shown is an illustration of a synthetic object based on a CAD model on a synthetic background. Labeled images can be generated synthetically using CAD models and synthetic backgrounds. This has been shown to work well, but relies on availability of CAD model, which is often not available. However, the concepts for generating the labeled images can be used with the present teachings.

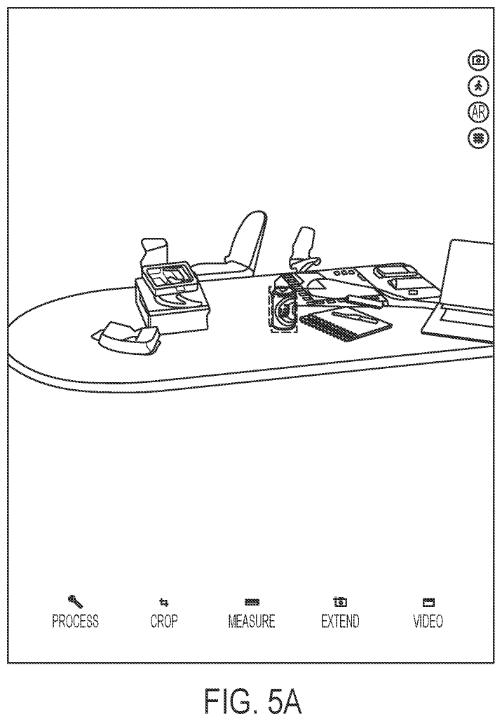

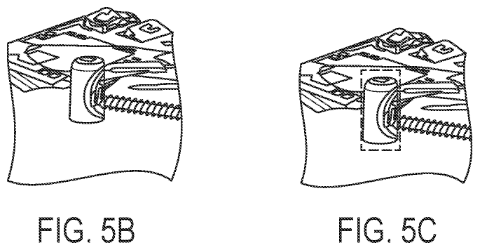

Referring now to FIGS. 5A-C, shown are illustrations of a captured scene that is annotated. A 3D frozen mesh may be captured, for example, by scanning different angles. In FIG. 5A, objects on a captured scene may be annotated on a textured mesh with an annotation cube. This could be done at the time of scanning or offline (e.g., after upload to AI platform). As shown, a bounding box (e.g., cube) may be placed over an object of interest (e.g., soda can). In FIG. 5B, shown is a two-dimensional image with the camera pose in the same world coordinate system as the 3D mesh. FIG. 5C shows that two-dimensional image having the bounding box (e.g., annotation from 3D mesh) projected thereon.

In one embodiment according to the present teachings, a scan (e.g., 3D mesh) without annotations and images with camera pose metadata may be uploaded for processing. The captured 3D mesh of the object and its environment has a well-defined coordinate space. Each image has the camera's 6DOF pose, which corresponds to the coordinate space of the 3D mesh. The 3D scene can be annotated after upload and the annotations can be projected onto the images to create the labelled image set. The “scanning user” (with user device 102) does not need to annotate the live scene, but it can instead be performed on the backend (by computing system 114).

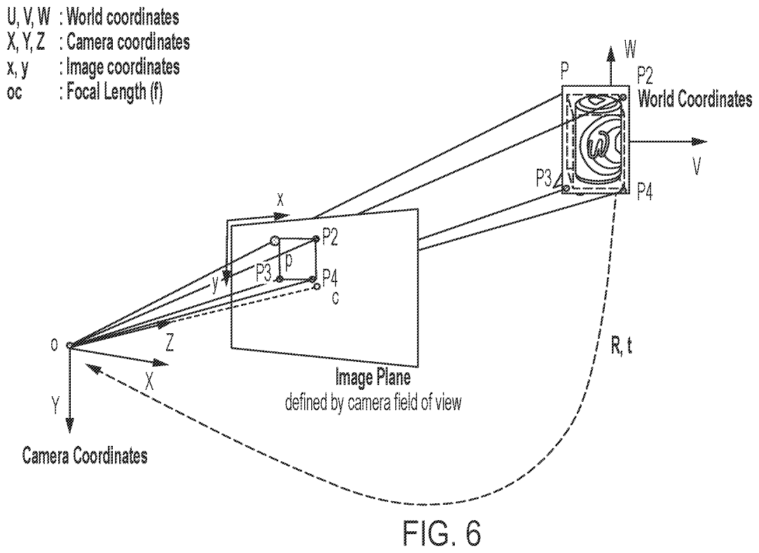

Referring now to FIG. 6, shown is an illustration of an example projection according to the present teachings. Using camera information (e.g., coordinates, focal length, etc.) an annotation can be projected onto two-dimensional images to build a labelled image data set that can then be used for training an object detector.

Often, images captured do not cover all of the necessary angles and distances, so it may be preferable to create new images. According to the present teachings, additional labeled images can be generated (manually or automatically) by moving a virtual “camera” around in the captured 3D scene (similarly to how synthetic capture works).

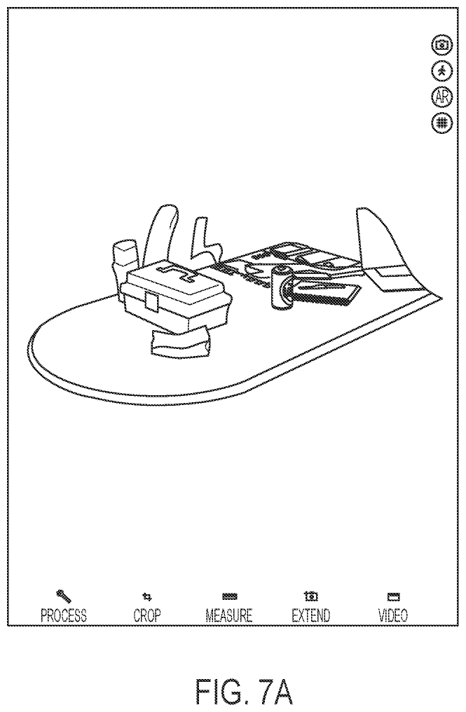

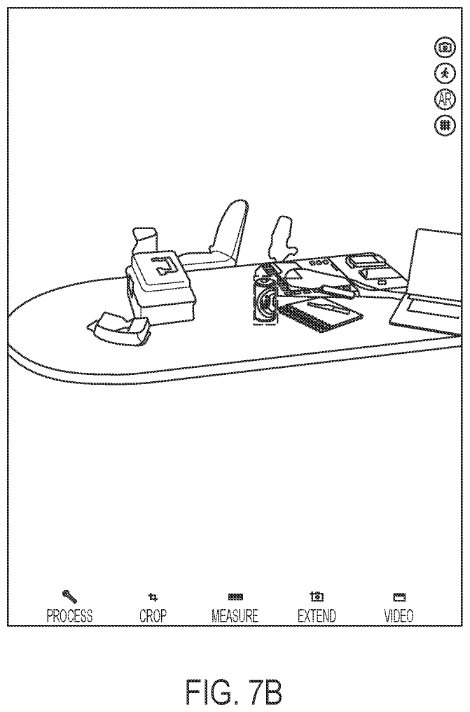

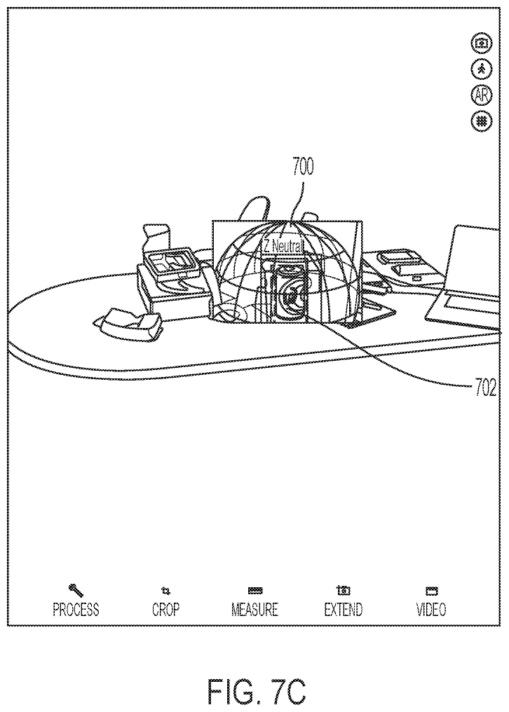

Referring now to FIGS. 7A-7C, shown are illustrations of example perspectives of a 3D frozen mesh. According to the present teachings, the system may be used to capture the annotated scene from different angles and distances (e.g., 360 degrees). In addition, it is possible to vary lighting conditions.

As shown in FIG. 7A, the 3D frozen mesh can be captured by scanning over angles where it is desirable to capture images. In FIG. 7B, objects can be annotated. This can be done at time of capture or later. Cubes (or other shapes, text, etc.) may be used. In FIG. 7C, scan limits may be applied to an object. Here, a transparent dome 700 is applied to the object of interest 702 (e.g., soda can). One skilled in the art appreciates that any number of different methods may be used for applying scan limits. A system according to the present teachings may then automatically scan the annotated scene from various angles and distances (e.g., may include all angles). Lighting and other conditions may also be varied. This capture may be done similarly to how synthetic capture is performed.

According to known methods, images with 2D bounding boxes (and their labels) are uploading by a user device to an AI (artificial intelligence) platform for processing. The user device creates the AR bounding cubes. To create stable bounding cubes, the AR framework (on the user device) creates a 3D mesh of the environment and anchors the cubes in that environment. 2D bounding boxes are rendered from cube max vertex extents, and boxes and labels are saved with each image. The AI platform then trains deep learning models using the labeled images (images with 2D bounding boxes and their labels).

There are many drawbacks of known methods. If a labeling mistake is made, for example, the user has to fix the annotation and rescan images with the user device. An alternative is to manually update images on the AI platform one by one. Neither approach is preferable. Common labeling mistakes include contradicting labels (both switch off and switch on over same area), drifting cubes (bounding box moves away from object of interest), bounding box too big or too small, and multiple labels for same object.

According to the present teachings, images may be uploaded by a user device to an AI (artificial intelligence) platform for processing, and include camera pose information. 2D bounding boxes (and labels) may be optional at the time of upload since they can be created on the AI platform. It is also possible to change annotation cubes, then re-create labels and bounding boxes on the AI platform. It is further possible to relabel images or add/remove labels later if mistakes were made during initial capture. If a part detection was not included initially, but is in the images, it can be added later.

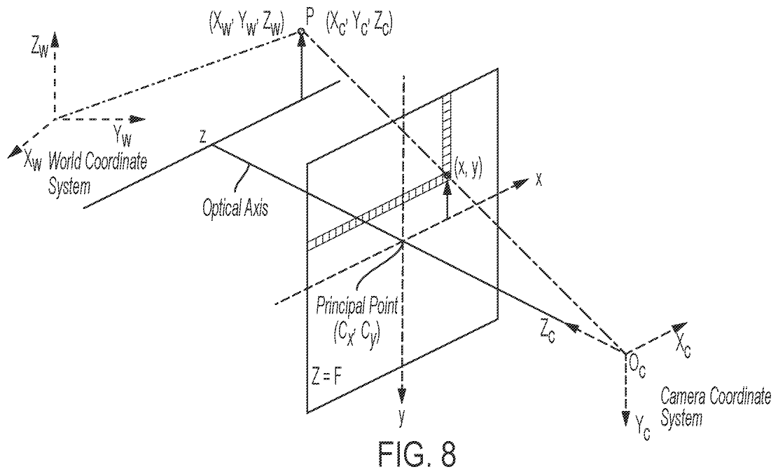

Referring now to FIG. 8, shown is an illustration of a projection of a camera coordinate system to a world coordinate system according to the present teachings. As discussed above, the annotation in the 3D scan and the camera pose information in the 2D images may share the same coordinate system, allowing the annotation to be accurately projected onto the 2D images.

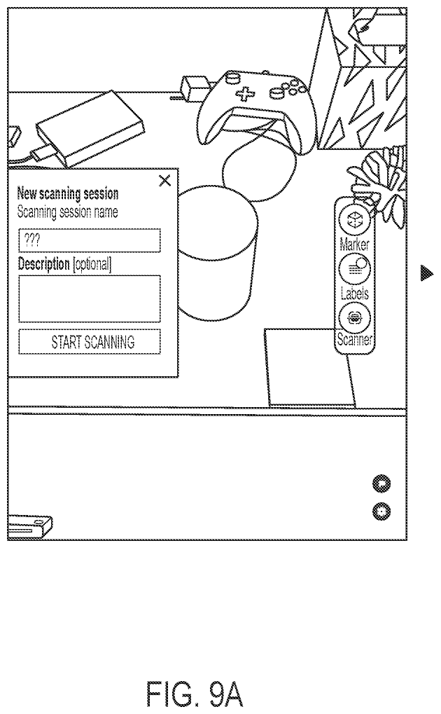

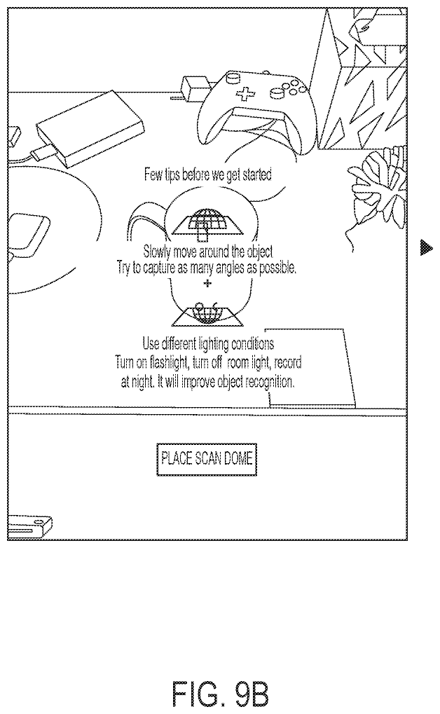

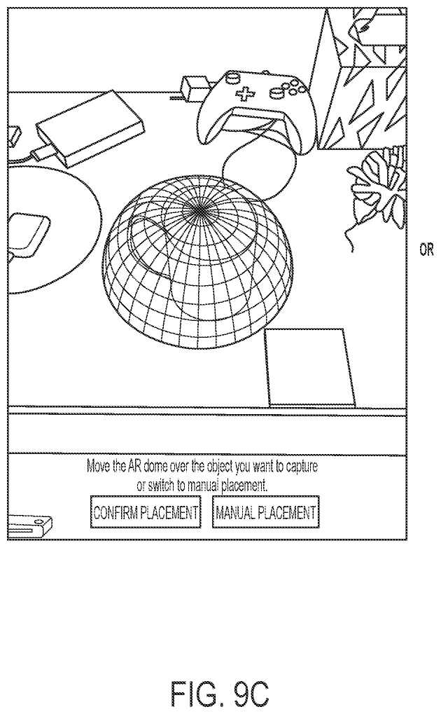

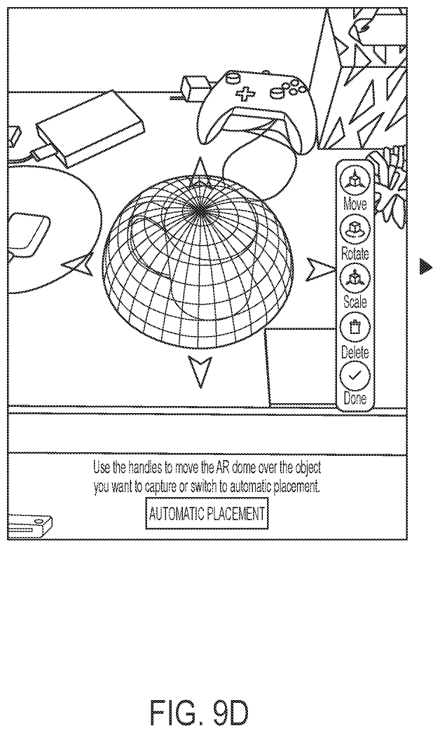

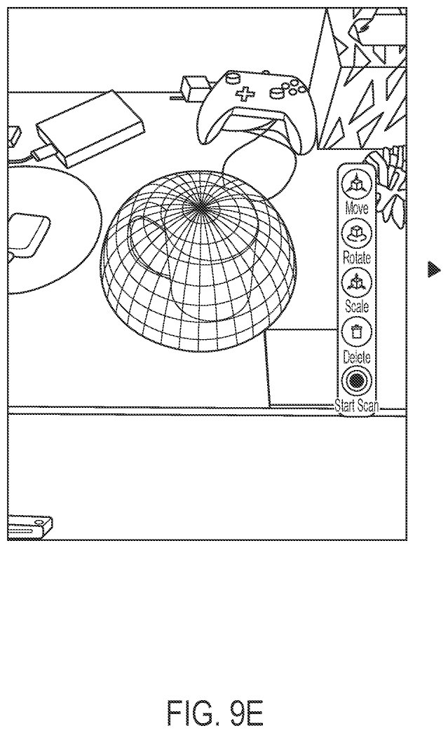

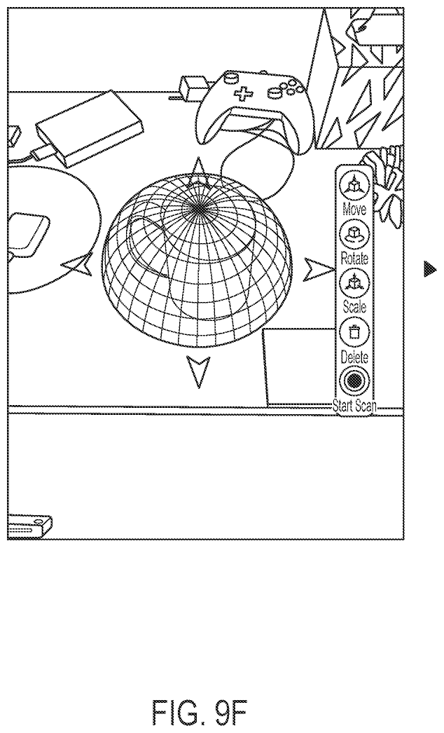

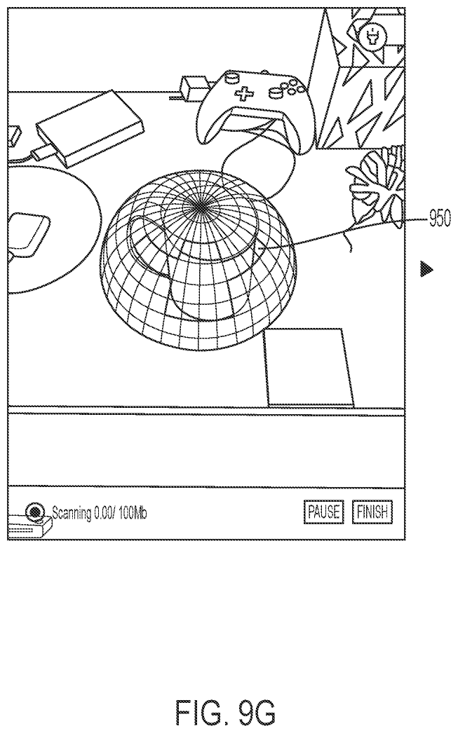

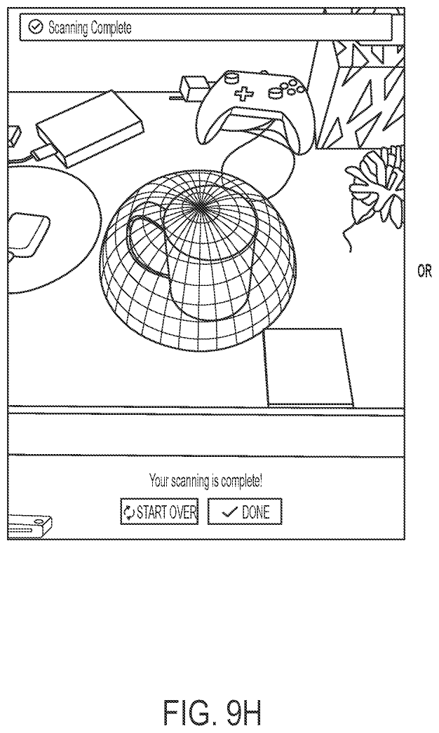

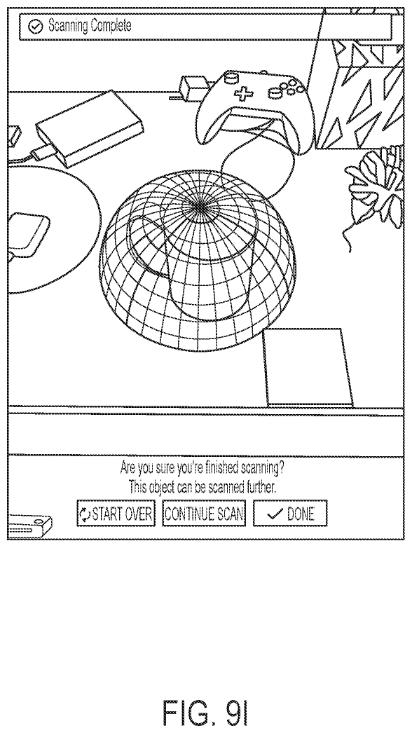

Referring now to FIGS. 9A-9I, shown are example user interfaces for scanning a scene. In FIG. 9A, a user opens an app (e.g., on user device 102) and starts a new scanning session. Selecting “Scanner” starts “dome capture”. FIG. 9B identifies some best practices and tips.

FIG. 9C shows automatic placement of the dome (or could be any other shape), although the user has the option to switch to manual placement. In FIG. 9D the user manually places guided capture dome (and distance threshold, etc.). Selecting “Done” finalizes placement and “Delete” removes it.

In FIG. 9E, once the dome is placed an adjustments bar may be made available. Selecting one may activate transform handles. In FIG. 9F adjustment options are available after a dome is placed. Deleting a dome may prompt to place a new dome or a user can select scan without one.

In FIG. 9G the scanning feature is activated. Moving around the dome will slowly remove the scanned dome sections 950, indicating that those perspectives have been captured. Although it may be difficult to see in the figure, the scanned dome section 950 is represented as clear, while the remaining section is represented as having a tint or some other indicator that it has not yet been scanned. A user can scan the entire object until whole dome is cleared. The app may capture a mesh as well as images (e.g., @ 2-3 fps). The images can contain camera pose information, such that the pose information and mesh information have the same coordinate system.

In FIG. 9H the scanning may complete automatically when all dome sections are cleared (or some other threshold set is met). In FIG. 9I if a user selected “Finish” before threshold is met, they have the option to continue scanning before finalizing.

A textured 3D mesh may be created from the scan (e.g., a sequence or video of 2D images). The 3D mesh and pose information for the 2D images may share the same coordinate system. In one embodiment, the coordinate system may be obtained from a user device's photogrammetry.

A system and method according to the present teachings provides a number of advantages. For example, it provides a much easier user experience. A user of a user device 102 may only need to scan the objects (e.g., for each state combination). Capturing labeled images from sufficient distances and angles can be challenging for users. The scene capture, annotation, and generation of the labelled set of images can be performed later and even automatically. In addition, changes in lighting can be simulated to capture labeled images in darker and lighter environments. Such a system more easily allows the use of an outsourced labeling service. An annotation service provider may be able to label images with better quality and accuracy, which improves machine learning training data.

Deep learning model testing can be done on the captured scene to help automate quality assurance. Deep learning model development is iterative and the present teachings allow a deep learning model to be created, tested, then iterated (by capturing more labeled images within the frozen mesh scene) with limited or no user interaction. In one embodiment, chroma key background augmentation may be used (either real or virtual) to generalize a model (train out background details)

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for generating a labelled image data set for use in object detection training, comprising:
a three-dimensional scan of an object and its environment in a coordinate space generated using a set of images taken by a user device;
the three-dimensional scan having an annotation of the object in the coordinate space;
position information of the user device in the coordinate space for each image in the set of images;
a computing system adapted to annotate the set of images by projecting the annotation of the object onto each image using the position information;
the computing system adapted to generate a labelled image set for teaching object detection using the annotated set of images.

2. The system of claim 1, wherein:
the three-dimensional scan is generated by the user device and sent to the computing system over the Internet;
the annotation is added to the three-dimensional scan by the user device, the annotation including a bounding box on the object;
the position information for each image is generated by the user device and sent to the computing system, the position information including six degrees of freedom information of the user device in the coordinate space.

3. The system of claim 1, wherein the set of images comprises video.

4. The system of claim 1, wherein the computing system is adapted to generate the three-dimensional scan using the set of images received from the user device.

5. The system of claim 1, wherein the position information for each image is generated by the computing system.

6. The system of claim 1, the set of images further comprising images generated by the computing system by varying perspective of the object in the three-dimensional scan.

7. The system of claim 1, wherein the annotation is added to the three-dimensional scan by the computing system.

8. The system of claim 1, wherein the annotation comprises a bounding box on the object.

9. An object model for object detection, comprising:
the labeled image data set generated by the system of claim 1;
the computing system adapted to generate the object model by training an object detector to identify the object using the labeled image data set, and using deep learning object detection neural networks.

10. The system of claim 1, wherein the computing system comprises a plurality of processors in communication over a network.

11. The system of claim 1, wherein each image of the set of images comprises depth information.

12. The system of claim 11, wherein each image of the set of images comprises an RGB-D image.

13. An augmented reality support platform, comprising:
a server having an object model generated by training an object detector using the labeled image data set generated by the system of claim 1;
the server adapted to receive video from a mobile device;
the server adapted to identify an object in the video using the object model;
the server adapted to annotate the video based on the identified object and transmit the annotated video to the mobile device for presentation;
wherein the identified object is a part of a product that is being supported;
the server is adapted to provide tasks for troubleshooting support of the product, and to detect whether a task has been completed.

14. A system for generating a labelled image data set for use in object detection training, comprising:
a computing system adapted to receive a sequence of images of an object and its environment taken by a user device, the computing system further adapted to receive position information of the user device in a coordinate space for at least one image of the sequence of images;
a three-dimensional scan of the object and its environment generated using the sequence of images, the three-dimensional scan having an annotation of the object in the coordinate space;
the computing system adapted to annotate the sequence of images by projecting the annotation of the object onto each image using the position information;
the computing system adapted to generate a labelled image set for teaching object detection using the annotated sequence of images.

15. An augmented reality support platform, comprising:
a server having an object model generated by training an object detector using the labeled image data set generated by the system of claim 14;
the server adapted to receive video from a mobile device;
the server adapted to identify an object in the video using the object model;
the server adapted to annotate the video based on the identified object and transmit the annotated video to the mobile device for presentation;
wherein the identified object is a part of a product that is being supported;
the server is adapted to provide tasks for troubleshooting support of the product, and to detect whether a task has been completed.

16. The system of claim 14, the set of images further comprising images generated by the computing system by varying perspective of the object in the three-dimensional scan.

17. The system of claim 14, wherein the sequence of images comprises video.

18. The system of claim 14, wherein the three-dimensional scan is generated by the user device.

19. A method for generating a labelled image data set for use in object detection training, comprising:
providing a three-dimensional scan of an object and its environment in a coordinate space generated using a set of images taken by a user device;
providing in the three-dimensional scan an annotation of the object in the coordinate space;
providing position information of the user device in the coordinate space for each image in the set of images;
annotating the set of images with a computing system by projecting the annotation of the object onto each image using the position information;
generating a labelled image set for teaching object detection using the annotated set of images.

20. The method of claim 19, wherein:
the three-dimensional scan is generated by the user device and sent to the computing system over the Internet;
the annotation is added to the three-dimensional scan by the user device, the annotation including a bounding box on the object;
the position information for each image is generated by the user device and sent to the computing system, the position information including six degrees of freedom information of the user device in the coordinate space.
